(19) United States
(12) Patent Application Publication
(10) Pub. No.: US 2018/0297401 A1
(43) Pub. Date: Oct. 18, 2018

(54) ELECTRIC DRIVE AXLE ASSEMBLY AND VEHICLE HAVING THE ELECTRIC DRIVE AXLE ASSEMBLY

(71) Applicant: BYD COMPANY LIMITED, Shenzhen (CN)

(72) Inventors: HUIYUE LIU, SHENZHEN (CN); JIA WEI, SHENZHEN (CN); CHUPENG QUAN, SHENZHEN (CN)

(21) Appl. No.: 16/015,898

(22) Filed: Jun. 22, 2018

Related U.S. Application Data
(63) Continuation of application No. PCT/CN2016/112660, filed on Dec. 28, 2016.

(30) Foreign Application Priority Data
Dec. 31, 2015 (CN) 201511031133.6
Dec. 31, 2015 (CN) 201521136312.1

(51) Int. Cl. B60B 35/16; B60B 35/14; B60K 17/08; B60K 17/16; B60K 11/02; B60K 1/00; B60T 1/06; B60T 8/32; F16H 57/021; F16H 57/00; B60T 1/00; F16H 61/02; B60B 35/12

(52) U.S. Cl. CPC B60B 35/16; B60B 2310/206; B60K 17/08; B60K 17/165; B60K 11/02; B60K 1/00; B60T 1/067; B60T 8/32; F16H 57/021; F16H 57/0025; B60T 1/005; F16H 61/0204; F16H 61/0265; B60B 35/124; B60B 2310/302; B60B 35/14

(57) ABSTRACT

The present disclosure discloses an electric drive axle assembly and a vehicle having the electric drive axle assembly. The electric drive axle assembly includes: an electric power assembly and an axle case assembly. The electric power assembly includes a power motor, a transmission, and a differential; the transmission has a transmission housing, the power motor being fixed to the transmission housing; the differential is supported on the transmission housing. The axle case assembly includes an axle case component and two half axles, the two half axles and the differential are both located inside the axle case component, and the transmission housing is fixed to the axle case component. For the electric drive axle assembly according to the embodiment of the present disclosure, the electric power assembly and the axle case assembly are integrated, which shortens a transmission chain, improves transmission efficiency, creates a compact structure and saves space.

### CROSS-REFERENCE TO RELATED APPLICATIONS

This application is a continuation application of International Patent Application No. PCT/CN2016/112660, filed on Dec. 28, 2016, which is based on and claims priority to and benefits of Chinese Patent Application Nos. 201511031133.6 and 201521136312.1, both filed with the State Intellectual Property Office of P. R. China on Dec. 31, 2015. The entire contents of the above-identified applications are incorporated herein by reference.

### FIELD

Embodiments of the the present disclosure relates to a technical field of electric vehicles, and particularly, to an electric drive axle assembly and a vehicle having the electric drive axle assembly.

### BACKGROUND

In the prior art, a power motor, a transmission, a transmission shaft, and a vehicle axle are all separately arranged, and power is transferred stage by stage, resulting in many transmission stages, a long transmission chain, a low transmission efficiency, a large volume, and difficulty for arrangement. Therefore, there is room for improvement.

### SUMMARY

The present disclosure is to solve one of the technical problems in the prior art at least to a certain degree. The present disclosure provides an electric drive axle assembly that has a small volume and a high integration degree.

The present disclosure further provides a vehicle having the electric drive axle assembly.

The electric drive axle assembly according to an embodiment of a first aspect of the present disclosure includes an electric power assembly that includes a power motor, a transmission, and a differential, the transmission having a transmission housing, the power motor being fixed to the transmission housing, and the differential being supported on the transmission housing; and an axle case assembly that includes an axle case component and two half axles, the two half axles and the differential being both located inside the axle case component, and the transmission housing being fixed to the axle case component.

For the electric drive axle assembly according to this embodiment of the present disclosure, the power motor, the transmission, the differential, and the axle case assembly are integrated, so that the structure is compact, assembly is simple, the mass is reduced, a small space is occupied, arrangement on a vehicle is convenient, a transmission chain is shortened, a transmission loss is small, and transmission efficiency is high.

According to some embodiments of the present disclosure, the power motor includes an active cooling structure that includes a coolant circulation passage for cooling the power motor.

According to some embodiments of the present disclosure, the active cooling structure further includes a coolant driving member coupled to the coolant circulation passage to drive a coolant to flow inside the coolant circulation passage.

According to some embodiments of the present disclosure, the axle case component includes: a first half axle case and a second half axle case that are both stamping pieces and are fixed through welding to form an axle case that defines a space for receiving the two half axles, the second half axle case and the first half axle case being symmetrically disposed in a longitudinal direction; and a case cover, detachably mounted to one of the first half axle case and the second half axle case to define a space for receiving the differential among the case cover, the first half axle case, and the second half axle case, in which the transmission housing is fixed to the other one of the first half axle case and the second half axle case.

According to some embodiments of the present disclosure, the axle case component includes: a first half axle case and a second half axle case that are both stamping pieces and are fixed through welding to form an axle case that defines a space for receiving the two half axles, the second half axle case and the first half axle case being symmetrically disposed in a vertical direction; and a case cover, detachably mounted to a side surface of the axle case to define a space for receiving the differential among the case cover, the first half axle case, and the second half axle case, where the transmission housing is fixed to another side surface of the axle case.

According to some embodiments of the present disclosure, two half axle sleeves are fixed through welding at two ends of the axle case component respectively, and the axle case assembly further includes two hub assemblies, each hub assembly being rotatably mounted to a corresponding half axle sleeve, and the two half axle sleeves being fitted over the two half axles in one-to-one correspondence.

According to some embodiments of the present disclosure, the axle case assembly further includes two brakes and two brake mounting plates, the two brakes corresponding to the two hub assemblies one to one, the two brake mounting plates being fixed through welding at two ends of the axle case component respectively, the two brakes being fixed to the two brake mounting plates in one-to-one correspondence by using threaded connecting pieces, and brake drums of the two brakes being fixed to the two hub assemblies in one-to-one correspondence.

According to some embodiments of the present disclosure, the axle case assembly further includes two ABS sensor components that are fixed to the two brake mounting plates in one-to-one correspondence by using threaded connecting pieces.

According to some embodiments of the present disclosure, the brake is a brake with a parking function.

According to some embodiments of the present disclosure, the transmission housing includes a first housing and a second housing, the first housing being detachably connected to the second housing, the power motor being fixed to the first housing, the second housing being fixed to the axle case component, and the differential being supported on the second housing.

According to some embodiments of the present disclosure, the transmission includes an input shaft, an intermediate shaft, and an output shaft. The input shaft is connected to a motor output shaft of the power motor and fixed with an input gear; an intermediate gear engaged with the input gear is fixed to the intermediate shaft, and a plurality of gear position driving gears are fixed to the intermediate shaft; an output gear engaged with a differential driven gear of the differential is fixed to the output shaft, and a plurality of gear position driven gears engaged with the plurality of gear position driving gears in one-to-one correspondence are freely fitted over the output shaft.

According to some embodiments of the present disclosure, an end, near the power motor, of the input shaft is supported on the first housing by using a first bearing, an end, away from the power motor, of the input shaft is supported on the first housing by using a second bearing, and the input gear is located between the first bearing and the second bearing.

According to some embodiments of the present disclosure, the first bearing and the second bearing are both angular contact ball bearings.

According to some embodiments of the present disclosure, the first bearing includes a pair of angular contact ball bearings assembled in series.

According to some embodiments of the present disclosure, a first bearing hole for supporting the first bearing and a second bearing hole for supporting the second bearing are provided in the first housing, and the first bearing hole and the second bearing hole are processed by using a same procedure.

According to some embodiments of the present disclosure, an end, away from the power motor, of the first housing is open, and a step portion is disposed at an end, near the power motor, of the first housing; and the transmission further includes an end cover and a separating sleeve, the separating sleeve being located inside the first housing, the end cover being fixed to the open end of the first housing, so as to tightly press an outer ring of the second bearing, the separating sleeve, and an outer ring of the first bearing onto the step portion, in which the outer ring of the second bearing, the separating sleeve, and the outer ring of the first bearing are sequentially disposed in an axial direction of the input shaft from an end away from the power motor to an end near the power motor.

According to some embodiments of the present disclosure, the transmission further includes an adjustment spacer, where the adjustment spacer is sandwiched between the first housing and the end cover and sandwiched between the end cover and the outer ring of the second bearing in an axial direction of the input shaft.

According to some embodiments of the present disclosure, the transmission further includes a directional screw, the directional screw being used to connect the separating sleeve and the first housing.

According to some embodiments of the present disclosure, a housing notch is disposed in a side, facing the intermediate shaft, of the first housing, a separating sleeve notch opposite the housing notch is disposed in a side, facing the intermediate shaft, of the separating sleeve, and the intermediate gear sequentially passes through the housing notch and the separating sleeve notch to be engaged with the input gear.

According to some embodiments of the present disclosure, a third bearing hole for supporting an end of the intermediate shaft is disposed in the first housing, and a diameter of the third bearing hole is less than a diameter of a mounting hole that is in the intermediate gear and is used for fitting and mounting of the intermediate shaft.

According to some embodiments of the present disclosure, the intermediate gear is fitted over the intermediate shaft and is fixed with the intermediate shaft by using a gear locking threaded piece; or the intermediate gear is connected to the intermediate shaft by using a spline structure, the transmission further includes an elastic retainer ring that is mounted to the intermediate gear, and at least one part of the intermediate shaft is sandwiched between the intermediate gear and the elastic retainer ring in an axial direction.

According to some embodiments of the present disclosure, the input gear, the intermediate gear, the output gear, the plurality of gear position driving gears, and the plurality of gear position driven gears are all helical gears.

According to some embodiments of the present disclosure, the input shaft is connected to the motor output shaft of the power motor by using a spline structure or a shaft coupling.

According to some embodiments of the present disclosure, the electric power assembly further includes a parking device, the parking device includes a parking device case, the parking device case is fixed to the second housing, and the parking device is configured to brake one of the differential driven gear, the output shaft, and the intermediate shaft.

According to some embodiments of the present disclosure, the electric power assembly further includes an electrohydraulic gear shift actuating module, and the electrohydraulic gear shift actuating module is configured to control the transmission and is mounted to the second housing.

A vehicle according to an embodiment of a second aspect of the present disclosure includes the electric drive axle assembly of the first aspect.

For the vehicle according to the embodiment of the present disclosure, the electric drive axle assembly of the embodiment of the first aspect is used, so that a transmission chain is short, a small space is occupied, and overall arrangement of the vehicle is facilitated.

### BRIEF DESCRIPTION OF THE DRAWINGS

FIG. 1 is a schematic structural view of an electric drive axle assembly according to an embodiment of the present disclosure;

FIG. 2 is a schematic structural semi-sectional view of an electric drive axle assembly according to an embodiment of the present disclosure;

FIG. 3 is an enlarged view of part E in FIG. 2;

FIG. 4 is a schematic structural view of an axle case assembly according to an embodiment of the present disclosure;

FIG. 5 is a schematic structural view of an axle case component according to an embodiment of the present disclosure;

FIG. 6 is a schematic structural view of an electric power assembly according to an embodiment of the present disclosure;

FIG. 7 is a schematic diagram of an internal structure of the inside of a transmission according to an embodiment of the present disclosure;

FIG. 8 is an exploded view of a transmission housing according to an embodiment of the present disclosure;

FIG. 9 is a schematic structural view of a parking device according to an embodiment of the present disclosure;

FIG. 10 is a schematic view of an embodiment of a mounting location of a parking device of an electric drive axle assembly according to the present disclosure;

FIG. 11 is a schematic view of another embodiment of a mounting location of a parking device of an electric drive axle assembly according to the present disclosure;

FIG. 12 is a schematic structural view of a transmission structure of an electric power assembly according to the present disclosure;

FIG. 13 is a partial schematic structural view of an embodiment of an electric power assembly according to the present disclosure;

FIG. 14 is a partial schematic structural view of another embodiment of an electric power assembly according to the present disclosure;

FIG. 15 is a schematic structural view of a separating sleeve according to an embodiment of the present disclosure;

FIG. 16 is a front view of a vehicle according to an embodiment of the present disclosure; and

FIG. 17 is a top view of a vehicle according to an embodiment of the present disclosure.

### DETAILED DESCRIPTION OF EMBODIMENTS

The embodiments of the present disclosure are described below in detail, and examples of the embodiments are shown in the accompanying drawings. The following embodiments that are described with reference to the accompanying drawings are exemplary, and are intended to explain the present disclosure rather than to be construed as a limitation to the present disclosure.

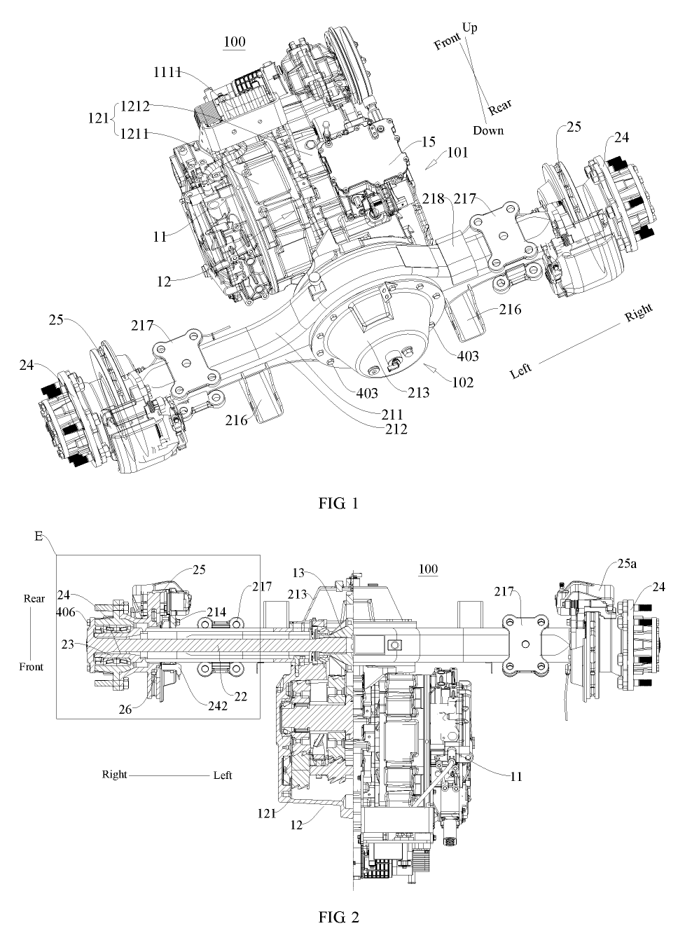

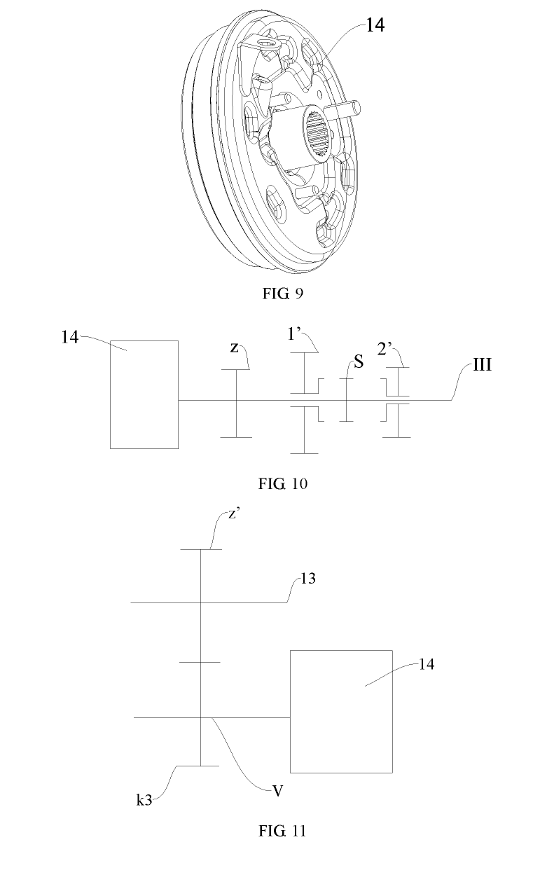

Referring to FIG. 1 to FIG. 17 below, an electric drive axle assembly 100 according to an embodiment of the present disclosure is described. As shown in FIG. 1 to FIG. 17, the electric drive axle assembly 100 according to the embodiment of the present disclosure includes an electric power assembly 101 and an axle case assembly 102.

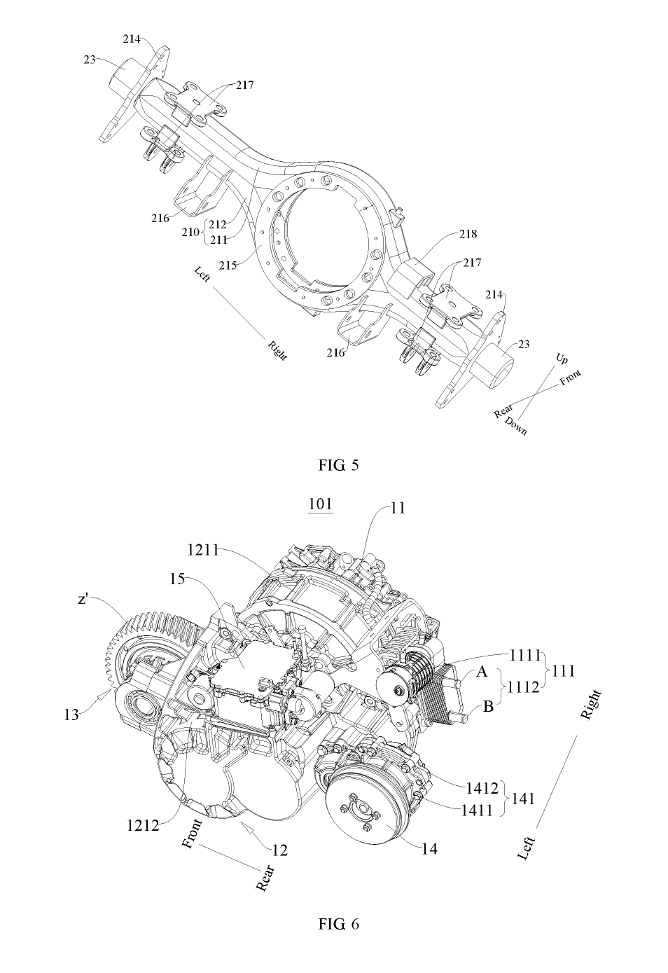

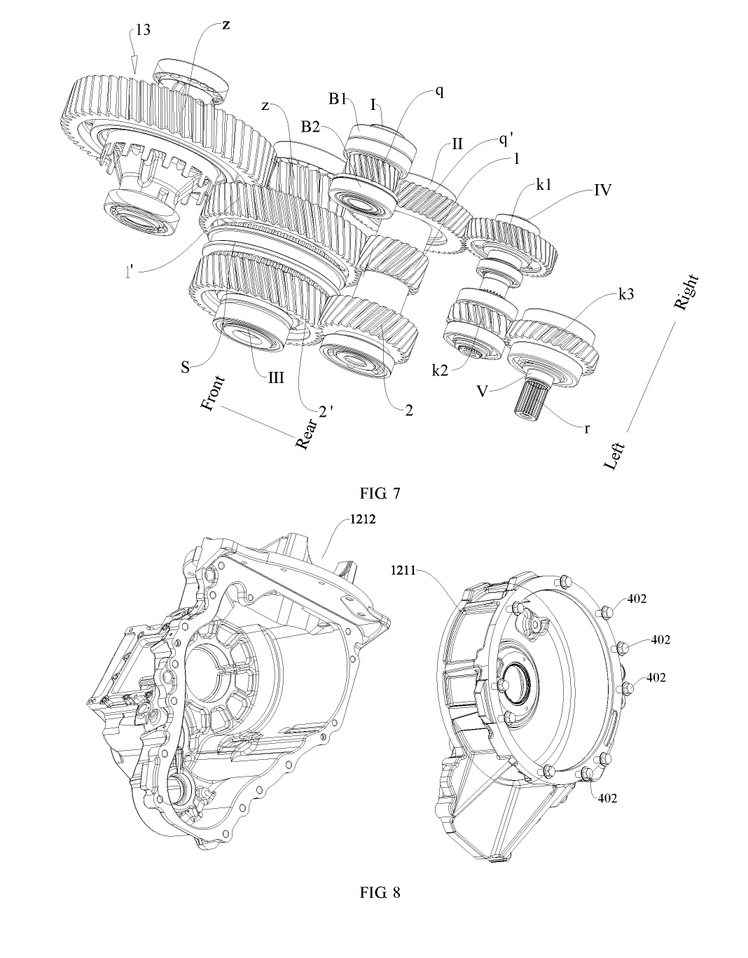

As shown in FIG. 1, FIG. 2, FIG. 6, and FIG. 7, the electric power assembly 101 includes a power motor 11, a transmission 12, and a differential 13. As shown in FIG. 1, FIG. 2, FIG. 4, and FIG. 5, the axle case assembly 102 includes an axle case component 21 and two half axles 22. The two half axles 22 and the differential 13 are located inside the axle case component 21.

It may be understood that, through speed change and torque adjustment of the transmission 12, power output by the power motor 11 is transferred to the differential 13, two output ends of the differential 13 output the power to the two half axles 22, and the half axles 22 transfer the power to wheels connected to the half axles 22, so as to drive a vehicle 1000 to travel.

As shown in FIG. 1 and FIG. 2, in the electric drive axle assembly 100 in this embodiment of the present disclosure, the transmission 12 has a transmission housing 121, the power motor 11 is fixed to the transmission housing 121, the differential 13 is supported on the transmission housing 121, and the transmission housing 121 is fixed to the axle case component 21. For example, in some embodiments of the present disclosure, the power motor 11 may be fixed to the transmission housing 121 by using a threaded connecting piece, the transmission housing 121 may be fixed to the axle case component 21 by using a threaded connecting piece, and the differential 13 is supported on the transmission housing 121 by using a bearing.

That is, in the electric drive axle assembly 100, the transmission housing 121 may be used as a mounting carrier for the power motor 11, and the transmission housing 121 is a member for connecting the electric power assembly 101 and the axle case assembly 102, so that the power motor 11, the transmission 12, the differential 13, and the axle case assembly 102 are integrated.

For the electric drive axle assembly 100 according to this embodiment of the present disclosure, the power motor 11, the transmission 12, the differential 13, and the axle case assembly 102 are integrated, so that the structure is compact, assembly is simple, the mass is reduced, a small volume is occupied, a small space is occupied, arrangement on the vehicle 1000 is convenient, a transmission chain is shortened, a transmission loss is small, and a transmission efficiency is high.

The electric drive axle assembly 100 according to this embodiment of the present disclosure is described below with reference to FIG. 1 to FIG. 17. As shown in FIG. 1 to FIG. 17, the electric drive axle assembly 100 according to this embodiment of the present disclosure includes the electric power assembly 101 and the axle case assembly 102. In an embodiment, the electric power assembly 101 may be fixed to the axle case assembly 102 by using a plurality of bolts 401, so that the electric power assembly 101 and the axle case assembly 102 are integrated into the electric drive axle assembly 100.

As shown in FIG. 1, FIG. 2, FIG. 6 to FIG. 8, and FIG. 10 to FIG. 15, the electric power assembly 101 includes the power motor 11, the transmission 12, the differential 13, an electrohydraulic gear shift actuating module 15, and a parking device 14, where the transmission 12 has the transmission housing 121.

As shown in FIG. 8, the power motor 11 may be fixed to the transmission housing 121 by using a plurality of bolts 402. The plurality of bolts 402 are disposed at intervals in a circumferential direction of the power motor 11. The power motor 11 may be a permanent-magnet synchronization motor. The power motor 11 is connected to an external power supply by using a three-phase wire, thereby implementing driving of the power motor 11.

As shown in FIG. 6, the power motor 11 includes an active cooling structure 111. The active cooling structure 111 is configured to actively cool the power motor 11. In some embodiments, the active cooling structure 111 includes a coolant circulation passage 1112 for cooling the power motor 11, and the power motor 11 is cooled through circulation of a coolant inside the coolant circulation passage 1112. As shown in FIG. 6, the coolant circulation passage 1112 has an inlet A and an outlet B. The coolant may enter the coolant circulation passage 1112 from the inlet A, and after performing thermal exchange with the power motor 11, the coolant is output from the outlet B.

Accordingly, the power motor 11 is provided with the active cooling structure 111, the power motor 11 may be prevented from being overheated, efficiency is indirectly improved, the power motor 11 is prevented from being burnt up, and high-power, high-rotational-speed, and long-time running requirements can be met, so that operating conditions of the vehicle 1000 are fit more desirably, and this can be used in full-series models from a light type to a heavy type.

In some embodiments, the active cooling structure 111 may further include a coolant driving member 1111, the coolant driving member 1111 is coupled to the coolant circulation passage 1112 to drive the coolant to flow inside the coolant circulation passage 1112. In an embodiment, the coolant driving member 1111 may be a cooling oil pump. Accordingly, the active cooling structure 111 is provided with the coolant driving member 1111, so that an integration degree is high, and assembly is simple.

Certainly, in some embodiments of the present disclosure, the coolant circulation passage 1112 may also be connected to the coolant located outside the electric drive axle assembly 100, that is, the coolant may be introduced from outside. For example, the coolant circulation passage 1112 of the active cooling structure 111 may share the coolant driving member with a coolant circulation passage of another member on the vehicle 1000.

The transmission housing 121 may be fixed to the axle case component 21 of the axle case assembly 102 by using the bolt 401. The transmission housing 121 includes a first housing 1211 and a second housing 1212. The first housing 1211 is detachably connected to the second housing 1212, in which the power motor 11 is fixed to the first housing 1211, the second housing 1212 is fixed to the axle case component 21, and the differential 13 is supported on the second housing 1212. The transmission housing 121 is configured in the form of a detachable connection, which may facilitate mounting of parts and components such as gears and shafts inside the transmission 12, so that collision of teeth does not occur during assembly, assembly manufacturability is desirable, and integration with the power motor 11 and the axle case component 21 is facilitated; moreover, mounting of the differential 13 inside the axle case component 21 may further become convenient.

The transmission 12 may include an input shaft I, an intermediate shaft II, and an output shaft III. The input shaft I, the intermediate shaft II, and the output shaft III are all supported on the transmission housing 121 by using a bearing. In an embodiment, as shown in FIG. 6 and FIG. 7, the input shaft I, the intermediate shaft II, and the output shaft III all extend in a width direction of the vehicle 1000, in which the width direction of the vehicle 1000 is a left-right direction of the vehicle 1000. The first housing 1211 and the second housing 1212 may be arranged in the left-right direction. For example, the second housing 1212 may be located at a left side of the first housing 1211. The power motor 11 may be arranged at a right side of the first housing 1211.

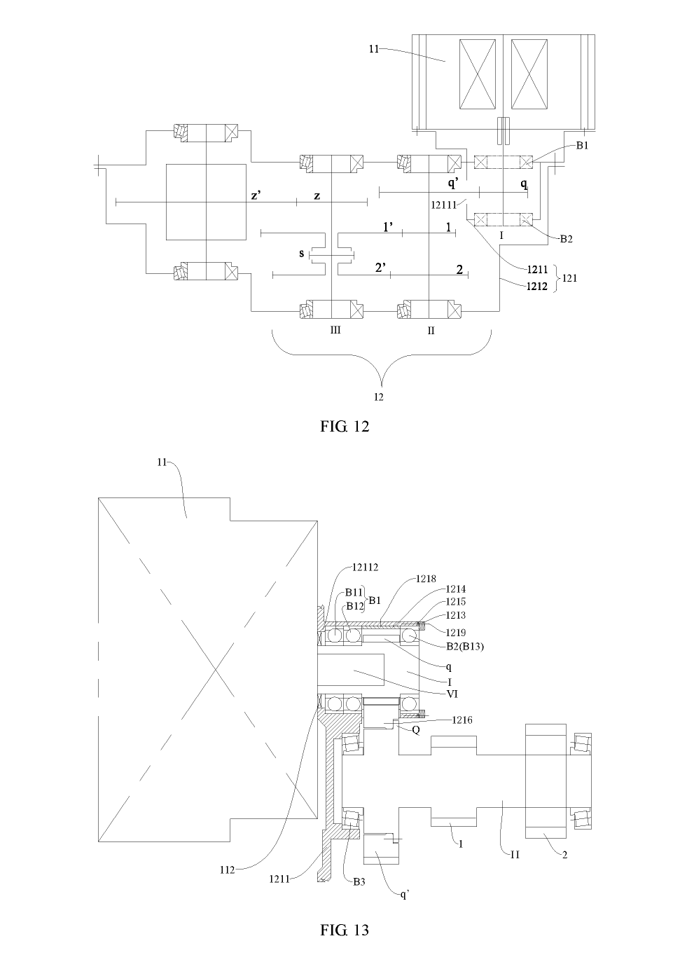

The input shaft I is connected to a motor output shaft VI of the power motor 11. For example, as shown in FIG. 12 to FIG. 14, the input shaft I may be connected to the power motor output shaft VI by using a spline structure. In an embodiment, the input shaft I has an inner spline, and the motor output shaft VI has an outer spline fitted with the inner spline. The input shaft I may also be connected to the motor output shaft VI by using a shaft coupling. For the electric power assembly 101 according to this embodiment of the present disclosure, the motor output shaft VI of the power motor 11 is directly connected to the input shaft I of the transmission 12, so that the transmission chain is short, and the structure is simple.

As shown in FIG. 7 and FIG. 12, an input gear q is fixed to the input shaft I, that is, the input gear q may rotate synchronously with the input shaft I. An intermediate gear q′ is fixed to the intermediate shaft II, that is, the intermediate gear q′ may rotate synchronously with the intermediate shaft II. The intermediate gear q′ is engaged with the input gear q. A plurality of gear position driving gears are fixed to the intermediate shaft II. The plurality of gear position driving gears may rotate synchronously with the intermediate shaft II. A plurality of gear position driven gears are freely fitted over the output shaft III, that is, each gear position driven gear may rotate relative to the output shaft III. The plurality of gear position driven gears are engaged with the plurality of gear position driving gears in one-to-one correspondence. In an embodiment, there are plurality of lengths and structures of the intermediate shaft II and the output shaft III, and different numbers of pairs of engaged gears may also be provided on the intermediate shaft II and the output shaft III, so that the transmission 12 has outputs of more gear positions.

In an embodiment, an output gear z is further fixed to the output shaft III, that is, the output gear z may rotate synchronously with the output shaft III. The output gear z may be engaged with a differential driven gear z′ of the differential 13, so that power output by the power motor 11 is transferred to the differential 13 through the transmission 12, and the half axles 22 and the wheels are driven by using the differential 13, thereby making the vehicle 1000 run.

In an embodiment, in some embodiments shown in FIG. 12 to FIG. 14, an end, near the power motor 11, of the input shaft I is supported on the first housing 1211 by using a first bearing B1, that is, power is input from an end of the input shaft I to the input shaft I, in which the end of the input shaft I is, the end, near the power motor 11, of the input shaft I. In some embodiments, an oil seal 112 may be disposed between the end of the input shaft I and the first housing 1211, to prevent lubricating oil in the transmission 12 from entering the power motor 11, thereby improving working reliability of the power motor 11.

An end, away from the power motor 11, of the input shaft I, that is, the other end of the input shaft I is supported on the first housing 1211 by using a second bearing B2. As shown in FIG. 12 to FIG. 14, both ends of the input shaft I are supported on the first housing 1211, instead of being supported on different housings respectively, thereby achieving desirable alignment property, and avoiding misalignment caused by an assembly error in an assembly process.

In some embodiments, the first bearing B1 and the second bearing B2 are both angular contact ball bearings. Accordingly, the input shaft I can bear a high rotational speed of the power motor 11, and use of the angular contact ball bearings may meet assembly precision requirements of the input shaft I more desirably.

In some embodiments, the first bearing B1 may include a pair of angular contact ball bearings assembled in series, and accordingly, forces applied on the first bearing B1 may be optimized, so that the service life of the first bearing B1 is indirectly extended.

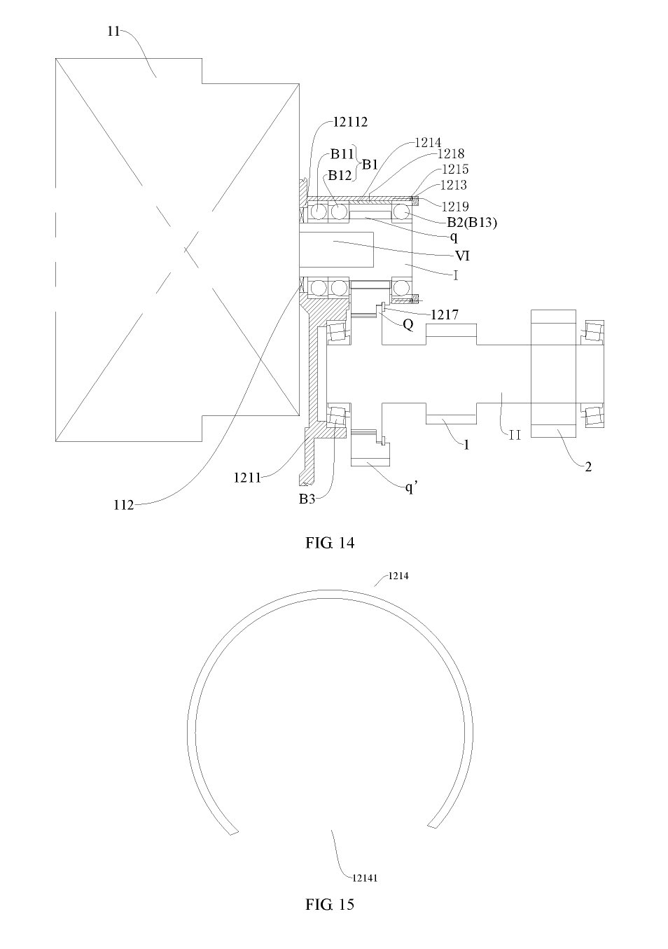

As shown in FIG. 13 and FIG. 14, the input gear q is located between the first bearing B1 and the second bearing B2. The first bearing B1 and the second bearing B2 are respectively located at two sides of the input gear q. The first bearing B1 includes an angular contact ball bearing B11 and an angular contact ball bearing B12, and the second bearing B2 includes an angular contact ball bearing B13, in which the angular contact ball bearing B11 and the angular contact ball bearing B12 are assembled in series at a side, near the power motor 11, of the input gear q, and the angular contact ball bearing B13 is assembled at a side, away from the power motor 11, of the input gear q. The angular contact ball bearing B13 and the angular contact ball bearing B12 may be assembled face to face.

In some embodiments of the present disclosure, the angular contact ball bearing B13 and the angular contact ball bearing B12 may also be assembled back to back.

In some embodiments, as shown in FIG. 13 and FIG. 14, a first bearing hole for supporting the first bearing B1 and a second bearing hole for supporting the second bearing B2 are provided in the first housing 1211, the first bearing hole and the second bearing hole are processed by using a same procedure. The first bearing hole and the second bearing hole are both located in the first housing 1211, and the first bearing hole and the second bearing hole may be synchronously processed by using the same procedure, for example, processed through one cut. Accordingly, in a process, the same procedure is used to perform synchronous processing, so as to ensure a coaxial degree of bearing holes, so that the first bearing B1 and the second bearing B2 (for example, the angular contact ball bearing B11, the angular contact ball bearing B12, and the angular contact ball bearing B13) each work in an optimal state.

As shown in FIG. 12 to FIG. 14, an end, away from the power motor 11, of the first housing 1211 is open, that is, the first housing 1211 has an open end, and the open end is away from an end of the input shaft I. A step portion 12112 is disposed at an end, near the power motor 11, of the first housing 1211, and the step portion 12112 is near the end of the input shaft I.

In an embodiment, the transmission 12 further includes an end cover 1213, a separating sleeve 1214, and an adjustment spacer 1215. The separating sleeve 1214 is located inside the first housing 1211, and the separating sleeve 1214 is fitted over the input shaft I. That is, in a radial direction of the input shaft I, the first housing 1211, the separating sleeve 1214, and the input shaft I are sequentially disposed from outside to inside. The end cover 1213 is fixed to the open end of the first housing 1211, that is, the end cover 1213 is fixed to the open end of the first housing 1211, so as to tightly press an outer ring of the second bearing B2, the separating sleeve 1214, and an outer ring of the first bearing B1 against the step portion 12112 of the first housing 1211, in which the outer ring of the second bearing B2, the separating sleeve 1214, and the first bearing B1 are sequentially disposed from the end away from the power motor 11 to the end near the power motor 11 in an axial direction of the input shaft I.

The end cover 1213 is fixed to the open end of the first housing 1211, so that the outer ring of the second bearing B2, the separating sleeve 1214, and the first bearing B1 may be sandwiched between the step portion 12112 of the first housing 1211 and the end cover 1213 in the axial direction of the input shaft I.

In the axial direction of the input shaft I, the separating sleeve 1214 is sandwiched between an outer ring of the angular contact ball bearing B12 and an outer ring of the angular contact ball bearing B13. In this way, relative widths of the separating sleeve 1214 and the input gear q may be adjusted to adjust pre-tight of an angular contact ball bearing. Further, to prevent the separating sleeve 1214 from rotation, the transmission 12 may further include a directional screw 1218, and the directional screw 1218 is used to connect the separating sleeve 1214 and the first housing 1211, so as to lock the separating sleeve 1214.

In the axial direction of the input shaft I, the adjustment spacer 1215 is sandwiched between the first housing 1211 and the end cover 1213, and the adjustment spacer 1215 is sandwiched between the outer ring of the second bearing B2 and the end cover 1213, in which the end cover 1213 is locked to the first housing 1211 by using an end cover tightening screw 1219. The thickness of the adjustment spacer 1215 is adjusted, so that influence on assembly precision of the first bearing B1 and the second bearing B2 due to a processing error of the first housing 1211 can be reduced.

Because the input gear q is located between the first bearing B1 and the second bearing B2, the first bearing B1 and the second bearing B2 are both supported on the first housing 1211, so that the input gear q is completely covered inside the first housing 1211. To accomplish engagement between the input gear q and the intermediate gear q′, a housing notch 12111 needs to be provided in a side, facing the intermediate shaft II, of the first housing 1211, and a separating sleeve notch 12141 needs to be provided in a side, facing the intermediate shaft II, of the separating sleeve 1214, in which the housing notch 12111 and the separating sleeve notch 12141 are opposite. In this way, the intermediate gear q′ may sequentially pass through the housing notch 12111 and the separating sleeve notch 12141 to be engaged with the input gear q.

In an embodiment, a third bearing hole for supporting an end (an end near the power motor 11) of the intermediate shaft II is provided in the first housing 1211. For example, as shown in FIG. 12 to FIG. 14, the end of the intermediate shaft II is supported inside the third bearing hole by using a third bearing B3. The intermediate gear q′ has a mounting hole, and the mounting hole is used to fit the intermediate shaft II. The intermediate shaft II and the mounting hole are fit by using a shaft hole or by using a spline structure, so as to implement the mounting of the intermediate gear q′ to the intermediate shaft II. A diameter of the third bearing hole is less than a diameter of the mounting hole. It can be understood that, the mounting hole may be understood in a broad sense, and may be a light hole or may be a hole having an inner spline.

It may be understood that, the third bearing hole and the intermediate shaft II are coaxially disposed. A projection of the third bearing hole on a plane perpendicular to the intermediate shaft II is a circle, for example, a circle 1. A projection of the mounting hole on the plane perpendicular to the intermediate shaft II is also a circle, for example, a circle 2. The circle 1 and the circle 2 are concentric, and a diameter of the circle 1 is less than a diameter of the circle 2. The diameter of the third bearing hole is an outer diameter of the third bearing B3, and the diameter of the mounting hole is a diameter of a partial shaft segment of the intermediate shaft II that is fitted with the mounting hole.

In an embodiment, there may be a plurality of manners of mounting the intermediate gear q′. In a specific example shown in FIG. 13, the intermediate gear q′ is fitted over the intermediate shaft II, and the intermediate gear q′ is fixed with the intermediate shaft II by using a gear locking threaded piece 1216. In an embodiment, the gear locking threaded piece 1216 is a locking screw. An axial direction of the locking screw is parallel to an axial direction of the intermediate shaft II, the intermediate shaft II is provided with a flange portion Q that extends outwardly in a radial direction, the intermediate gear q′ is fixed to the flange portion Q by using a locking screw, and the intermediate gear q′ is pressed against an end face of the flange portion by using a locking screw.

During assembly of the transmission 12, first, the intermediate gear q′ is engaged with the input gear q; the third bearing B3 is then pressed to the intermediate shaft II; an end of the intermediate shaft II to which the third bearing B3 is pressed and the plurality of gear position driving gears are mounted then passes through the mounting hole of the intermediate gear q′ to be mounted inside a hole of the third bearing B3; and subsequently the intermediate gear q′ and the flange portion Q of the intermediate shaft II are fixed by using the gear locking threaded piece 1216. Accordingly, the assembly is convenient, assembly efficiency is high, positioning of the intermediate gear q′ in an axial direction is implemented by fitting of the flange portion Q and the locking screw, and the intermediate gear q′ has a simple mounting structure.

As shown in FIG. 14, the intermediate gear q′ may be connected to the intermediate shaft II by using a spline structure, the transmission 12 may further include an elastic retainer ring 1217, the elastic retainer ring 1217 is mounted to the intermediate gear q′, and at least one part of the intermediate shaft II is sandwiched between the intermediate gear q′ and the elastic retainer ring 1217 in the axial direction, that is, positioning of the intermediate gear q′ in the axial direction is performed by fitting between the at least one part of the intermediate shaft II and the elastic retainer ring 1217. In an embodiment, the intermediate shaft II is provided with the flange portion Q that extends outwardly in the radial direction, the flange portion Q is at least one part of the intermediate shaft II, and the flange portion Q is sandwiched between the elastic retainer ring 1217 and the intermediate gear q′, so that positioning of the intermediate gear q′ in the axial direction is implemented.

During assembly of the transmission 12, first, the intermediate gear q′ is engaged with the input gear q; the third bearing B3 is then pressed to the intermediate shaft II; the end of the intermediate shaft II to which the third bearing B3 is pressed and the plurality of gear position driving gears are mounted then passes through the mounting hole of the intermediate gear q′ to be mounted inside the hole of the third bearing B3; and subsequently positioning of the intermediate gear q′ in the axial direction is implemented by fitting between the flange portion and the elastic retainer ring 1217. Accordingly, the assembly is convenient, the assembly efficiency is high, and the intermediate gear q′ has the simple mounting structure. In addition, to facilitate mounting of the elastic retainer ring 1217, the width of the intermediate gear q′ is relatively large, so that transmission is smoother, and a radial size of the elastic retainer ring 1217 is relatively small, so that more space can be saved, and assembly is also more convenient.

In some embodiments, the input gear q, the intermediate gear q′, the plurality of gear position driving gears, and the plurality of gear position driven gears are all helical gears. In an embodiment, the output gear z is also a helical gear. Accordingly, transmission gears of the electric power assembly 101 are all helical gears, so that the entire transmission 12 has smooth transmission, low noise, high transmission efficiency, and large transmission torque.

In some embodiments, as shown in FIG. 1 and FIG. 6, the electric power assembly 101 may further include the electrohydraulic gear shift actuating module 15. The electrohydraulic gear shift actuating module 15 is configured to control the transmission 12, and the electrohydraulic gear shift actuating module 15 is mounted to the second housing 1212. A sensor and a precise flow valve both fitted with the electrohydraulic gear shift actuating module 15 are mounted to the electrohydraulic gear shift actuating module 15, and an external electronic control unit may make a response by using a collected signal, so that a shifting speed and a shifting time point of the transmission 12 can be precisely controlled, so that the transmission 12 has smooth shifting, a fast response speed, and desirable operability, and driving fatigue may be relieved.

As shown in FIG. 6 and FIG. 9 to FIG. 11, in some embodiments of the present disclosure, the electric power assembly 101 may include the parking device 14. The parking device 14 includes a parking device case 141, and the parking device case 141 may be fixed to the second housing 1212.

In an embodiment, as shown in FIG. 6, the parking device case 141 may include a first parking device case 1411 and a second parking device case 1412. The first parking device case 1411 is detachably connected to the second parking device case 1412. The parking device 14 is mounted to the first parking device case 1411, and the second parking device case 1412 is fixed to the second housing 1212. Accordingly, the electric power assembly 101 is integrated with the parking device 14, so that a parking function can be implemented simply and reliably.

There may be various locations where the parking device 14 may be mounted. For example, the parking device 14 can be used to brake one of the differential driven gear z′, the output shaft III, and the intermediate shaft II. Specifically, in an embodiment shown in FIG. 10, the parking device 14 is configured to directly brake the output shaft III. When there is a gear position, the parking device 14 is pulled to implement a central parking function. The parking structure in this embodiment is simple and reliable.

In an embodiment shown in FIG. 11, the parking device 14 can be used to brake the differential driven gear z′. When the parking device 14 is configured to brake the differential driven gear z′, the parking function can be implemented without need of switching a gear position. The parking structure in this embodiment has a compact structure. In an embodiment, the parking device 14 is connected to a parking shaft V, for example, by using a spline structure. A third transition gear k3 is fixed to the parking shaft V. The third transition gear k3 may be engaged with the differential driven gear z′, and the parking device 14 brakes the third transition gear k3 to indirectly brake the differential driven gear z′.

In some embodiments shown in FIG. 7, the parking device 14 may also brake the intermediate shaft II. In this embodiment, the parking device 14 is also pulled when there is a gear position, so as to implement the central parking function. The parking structure in this embodiment is simple and reliable.

It may be seen from the foregoing description, there are various locations where the parking device 14 may be mounted. A suitable location may be determined according to a specific arrangement requirement of the vehicle 1000, so as to adapt to requirements of different vehicle models, and the electric power assembly 101 has a wide range of application.

Some embodiments of the transmission 12 according to the present disclosure are described below with reference to FIG. 6, FIG. 7, and FIG. 12. As shown in FIG. 7, the transmission 12 includes the input shaft I, the intermediate shaft II, the output shaft III, a transition shaft IV, the parking shaft V, and a synchronizer S.

The plurality of gear position driving gears include a first-gear driving gear 1 and a second-gear driving gear 2. The first-gear driving gear 1 and the second-gear driving gear 2 are fixed to the intermediate shaft II at an interval in the axial direction of the intermediate shaft II. The plurality of gear position driven gears include a first-gear driven gear 1′ and a second-gear driven gear 2′. The first-gear driving gear 1 is engaged with the first-gear driven gear 1′, the second-gear driving gear 2 is engaged with the second-gear driven gear 2′, and the first-gear driven gear 1′ and the second-gear driven gear 2′ are freely fitted over the output shaft III at an interval in an axial direction of the output shaft III. The synchronizer S is configured to selectively join one of the first-gear driven gear 1′ and the second-gear driven gear 2′ to the output shaft III. That is, the synchronizer S may join the first-gear driven gear 1′ to the output shaft III to enable the first-gear driven gear 1′ and the output shaft III to rotate synchronously. The synchronizer S may also join the second-gear driven gear 2′ to the output shaft III to enable the second-gear driven gear 2′ and the output shaft III to rotate synchronously. The synchronizer S may be located at an intermediate location where the first-gear driven gear 1′ is not joined to the output shaft III and the second-gear driven gear 2′ is not joined to the output shaft III, that is, a neutral gear position. The output gear z is fixed to the output shaft III.

As shown in FIG. 7, the synchronizer S is located between the first-gear driven gear 1′ and the second-gear driven gear 2′, and the output gear z is located at a side, away from the second-gear driven gear 2′, of the first-gear driven gear 1′. Two ends of the input shaft I may be supported on the first housing 1211 respectively by using tapered roller bearings at two ends. An end of the intermediate shaft II may be supported on the first housing 1211 by using the tapered roller bearing, and the other end of the intermediate shaft II may be supported on the second housing 1212 by using the tapered roller bearing. An end of the output shaft III may be supported on the first housing 1211 by using the tapered roller bearing, and the other end of the output shaft III may be supported on the second housing 1212 by using the tapered roller bearing.

As shown in FIG. 7, a first transition gear k1 and a second transition gear k2 are fixed to the transition shaft IV. The first transition gear k1 and the second transition gear k2 are disposed at an interval in an axial direction of the transition shaft IV, and the third transition gear k3 is fixed to the parking shaft V. In this embodiment, the first transition gear k1 is engaged with the intermediate gear q′, and the second transition gear k2 is engaged with the third transition gear k3.

As shown in FIG. 7, parts, located at two ends of the first transition gear k1, of the transition shaft IV are supported on the first housing 1211 and the second housing 1212 respectively by using a bearing. Parts, located at two ends of the second transition gear k2, of the transition shaft IV are supported on the first parking device case 1411 and the second parking device case 1412 respectively by using a bearing. An end of the parking shaft V is supported on the first housing 1211 by using a bearing, the other end of the parking shaft V is supported on the second housing 1212 by using a bearing. The end of the parking shaft V has a spline r, and the parking device 14 is fitted over the spline r, so that the parking shaft V may actuate a brake drum of the parking device 14 to rotate.

When the transmission 12 is working, power output by the power motor 11 is output to the input shaft I, the input gear q on the input shaft I transmits the power to the intermediate gear q′ on the intermediate shaft II, and the intermediate gear q′ actuates the intermediate shaft II to rotate. When the synchronizer S is at the intermediate location, the first-gear driven gear 1′ and the second-gear driven gear 2′ rotate, but do not actuate the output gear z on the output shaft III to rotate, in which case it is in a neutral gear. When the synchronizer S is pushed to the first-gear driven gear 1′ to synchronize the first-gear driven gear 1′ with the output shaft III, in which case the transmission 12 is in the first gear, and the first-gear driven gear 1′ actuates the output gear z on the output shaft III to rotate. When the synchronizer S is pushed to the second-gear driven gear 2′ to synchronize the second-gear driven gear 2′ with the output shaft III, in which case the transmission 12 is in the second gear, and the second-gear driven gear 2′ actuates the output gear z on the output shaft III to rotate. The output gear z is engaged with the differential driven gear z′, and the differential driven gear z′ may be fixedly mounted to the differential 13 by using a threaded connecting piece or by welding, so as to actuate the differential 13 to rotate.

As shown in FIG. 7, the intermediate gear q′ is engaged with the first transition gear k1, power is output to the second transition gear k2 on the transition shaft IV, the second transition gear k2 is engaged with the third transition gear k3, the third transition gear k3 actuates the spline r on the parking shaft V to rotate, and the spline r actuates the brake drum on the parking device 14 to rotate, so as to indirectly implement braking of the intermediate shaft II.

In some embodiments, as shown in FIG. 7 and FIG. 12, the intermediate shaft II and the first-gear driving gear 1 are integrated, that is, the intermediate shaft II and the first-gear driving gear 1 are formed into a gear shaft; the second-gear driving gear 2 is detachably coupled to the intermediate shaft II, and accordingly, the structural strength is high and assembly is simple.

In an embodiment, because the diameter of the mounting hole of the intermediate gear q′ is greater than the diameter of the hole of the third bearing B3, the third bearing B3 may be first pressed onto the gear shaft, the second-gear driving gear 2 and a bearing for supporting the other end of the intermediate shaft II are then assembled, and finally the foregoing gear shaft assembled with the second-gear driving gear 2 is then inserted into the mounting hole of the intermediate gear q′ that is already engaged with the input gear q. The gear shaft and the mounting hole of the intermediate gear q′ are fit by using a shaft hole or a spline structure to ensure a coaxial degree, and are fixedly connected by using the gear locking threaded piece 1216. In this way, transmission of the intermediate gear q′ and the input gear q is used to implement a speed decrease and a torque increase.

In FIG. 7 and FIG. 12, the transmission 12 is a two-gear transmission 12, so that the structure is simple, the mass is small, a speed ratio is large, the torque is large, relatively strong power performance is achieved, relatively desirable manipulation performance is achieved, and use requirements of general vehicle models can be met.

The axle case assembly 102 of the electric drive axle assembly 100 according to this embodiment of the present disclosure is described below in detail with reference to FIG. 1 to FIG. 5. As shown in FIG. 1 to FIG. 5, the axle case assembly 102 includes the axle case component 21 and the two half axles 22. The two half axles 22 and the differential 13 of the electric drive axle assembly 100 both may be located inside a mounting space defined by the axle case component 21.

It may be understood that, in some embodiments, the lengths of the two half axles 22 may be consistent. In some embodiments, the lengths of the two half axles 22 may be inconsistent. For example, when a drum bag of the axle case component 21 has an eccentric structure, as shown in FIG. 2, the lengths of the two half axles 22 may be unequal, that is, one half axle 22 is long, and the other half axle 22 is short.

For the electric drive axle assembly 100 according to this embodiment of the present disclosure, the electric power assembly 101 and the axle case assembly 102 are integrated, that is, the electric drive axle assembly 100 is an integrated electric drive axle. The axle case component 21 is suitable to be fixed with the transmission housing 121 of the integrated electric drive axle.

The axle case component 21 may include a first half axle case 211, a second half axle case 212, and a case cover 213. The first half axle case 211 is a stamping piece, and the second half axle case 212 is also a stamping piece. The second half axle case 212 and the first half axle case 211 are fixed through welding to form an axle case 210, and the axle case 210 defines a space for receiving the two half axles 22. The axle case component 21 is formed by welding two half axle cases that are both stamping pieces, so that the structure is simple, the mass is small, and processing is easy, and the manufacturing cost is low.

In some embodiments, as shown in FIG. 5, the axle case assembly 102 may include at least one of a shock absorber mounting seat 216, a plate spring seat 217, and a stopper seat 218. At least one of the shock absorber mounting seat 216, the plate spring seat 217, and the stopper seat 218 are fixed to the axle case component 21 through welding. Accordingly, the axle case assembly 102 further can be used to mount a shock absorber and a plate spring and to stop the electric drive axle assembly 100, thereby preventing the electric drive axle assembly 100 from shaking, so that the functions are more perfect, the structure is simple and compact, and the manufacturing cost is low.

In an embodiment shown in FIG. 5, the axle case assembly 102 may further include the stopper seat 218, and two shock absorber mounting seats 216 and two plate spring seats 217 that are symmetrically disposed at two ends of the axle case component 21, in which the stopper seat 218 is coupled to the first half axle case 211 near the case cover 213. The shock absorber mounting seat 216 is coupled to the second half axle case 212. The plate spring seat 217 includes a first part fixed to the first half axle case 211 and a second part fixed to the second half axle case 212, in which the stopper seat 218, the shock absorber mounting seat 216, and the plate spring seat 217 are all located between two brake mounting plates 214.

In some embodiments, the second half axle case 212 and the first half axle case 211 are symmetrically disposed in a longitudinal direction, the case cover 213 is detachably mounted to one of the first half axle case 211 and the second half axle case 212, and the transmission housing 121 may be fixed to the other one of the first half axle case 211 and the second half axle case 212.

In this embodiment, how the case cover 213 may be disposed according to an arrangement form of the electric drive axle assembly 100 on the vehicle 1000. For example, when the electric power assembly 101 is located in front of the axle case assembly 102, and the first half axle case 211 is located in front of the second half axle case 212, the case cover 213 is coupled to the second half axle case 212, and the transmission housing 121 is fixed to the first half axle case 211. In contrast, the case cover 213 is coupled to the first half axle case 211, and the transmission housing 121 is fixed to the second half axle case 212. The case cover 213, the first half axle case 211, and the second half axle case 212 together define a space for receiving the differential 13.

In some embodiments, as shown in FIG. 4 and FIG. 5, the second half axle case 212 and the first half axle case 211 are symmetrically disposed in a vertical direction. The case cover 213 is detachably mounted to a side surface of the axle case 210, that is, a side surface of the first half axle case 211 and a side surface of the second half axle case 212 (for example, a rear side surface of the first half axle case 211 and a rear side surface of the second half axle case 212). The transmission housing 121 is fixed to the other side surface of the axle case 210, that is, the other side surface of the first half axle case 211 and the other side surface of the second half axle case 212 (for example, a front side surface of the first half axle case 211 and a front side surface of the second half axle case 212). The case cover 213, the first half axle case 211, and the second half axle case 212 together define a space for receiving the differential 13.

In an embodiment, the case cover 213 may be detachably mounted to a side surface of the axle case 210 by using a threaded connecting piece, that is, the first half axle case 211 and the second half axle case 212. In an embodiment, as shown in FIG. 1, the threaded connecting piece is a bolt 403, and the case cover 213 may be connected in a threaded manner to the rear side surface of the first half axle case 211 and the rear side surface of the second half axle case 212 by using the plurality of bolts 403 that are disposed at intervals in a circumferential direction of the case cover 213. In this way, the case cover 213 is detachably mounted to the two half axle cases, so that mounting of the electric power assembly 101 may be more convenient, a fixing structure is simple, and operations are convenient.

In this embodiment, the two half axle cases are symmetrically disposed in the vertical direction, to reduce influence on mounting precision of the case cover 213 due to a manufacturing error of the first half axle case 211 and the second half axle case 212, and to enhance the stability of the connection between the case cover 213 and the two half axle cases, a padding plate 215 is provided between the case cover 213 and the axle cases 210 (that is, the two half axle cases). The padding plate 215 may be fixed to a side surface of the axle case 210 through welding, that is, side surfaces of the first half axle case 211 and the second half axle case 212, and the case cover 213 is detachably coupled to the padding plate 215.

In an embodiment, as shown in FIG. 5, the padding plate 215 may be fixed through welding to the rear side surface of the first half axle case 211 and the rear side surface of the second half axle case 212, the padding plate 215 is sandwiched between the case cover 213 and the first half axle case 211, and the padding plate 215 is sandwiched between the case cover 213 and the second half axle case 212. The case cover 213 is detachably coupled to the padding plate 215 by using the plurality of bolts 403.

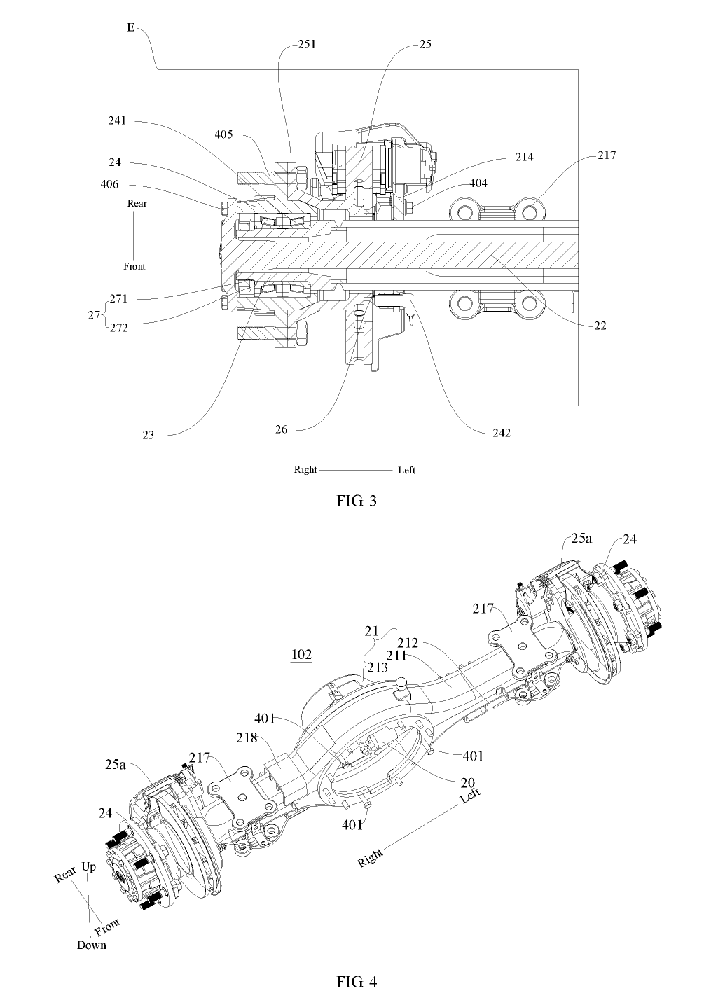

In an embodiment, as shown in FIG. 3 and FIG. 5, two half axle sleeves 23 may be fixed through welding at two ends respectively (that is, a left end and a right end) of the axle case component 21.

The axle case assembly 102 may further include two hub assemblies 24, two brakes 25, and the two brake mounting plates 214. Each hub assembly 24 is rotatably mounted to a corresponding half axle sleeve 23. The two half axle sleeves 23 are fitted over the two half axles 22 in one-to-one correspondence. The two brakes 25 correspond to the two hub assemblies 24 one to one, that is, one brake 25 corresponds to one hub assembly 24 to brake the hub assembly 24. The two brake mounting plates 214 are fixed through welding at the two ends of the axle case component 21 respectively. The two brakes 25 are fixed on the two brake mounting plates in one-to-one correspondence by using threaded connecting pieces 214, and brake drums 251 of the two brakes 25 are fixed to the two hub assemblies 24 in one-to-one correspondence.

The axle case assembly 102 may further include two axial stopper sets 27. The two axial stopper sets 27 correspond to the two hub assemblies 24 one to one. That is, each axial stopper set 27 corresponds to one hub assembly 24 to stop the hub assembly 24 in an axial direction. Each axial stopper set 27 includes a stop nut 271 and a locking sheet 272. The stop nut 271 and the locking sheet 272 are both fitted over a corresponding half axle sleeve 23, and the stop nut 271 and the corresponding half axle sleeve 23 are connected in a threaded manner to compress the corresponding hub assembly 24 between the locking sheet 272 and the brake drum 251 of the corresponding brake 25.

It may be understood that, the two hub assemblies 24, the two half axle sleeves 23, the two brakes 25, the two brake mounting plates 214, the two axial stopper sets 27, and the two half axles 22 all correspond one to one, and are symmetrically located at the left end and the right end of the axle case component 21 respectively in the width direction of the vehicle 1000.

The right end is used as an example below to describe connection relationships and location relationships among the hub assembly 24, the half axle sleeve 23, the brake 25, the brake mounting plate 214, and the axial stopper set 27 at this end.

In an embodiment, as shown in FIG. 3, one half axle sleeve 23 is welded at the right end of the axle case component 21, the hub assembly 24 at the right end is rotatably mounted to the half axle sleeve 23 at the right end, and the half axle sleeve 23 at the right end is fitted over the half axle 22 on the right side. The hub assembly 24 is a part of a wheel, and the rotation of the hub assembly 24 can implement the rotation of the wheel. In an embodiment, as shown in FIG. 3, the right end of the half axle 22 at the right end passes through the half axle sleeve 23 at the right end, and is fixed with the hub assembly 24 at the right end by using a threaded connecting piece (a bolt 406 shown in FIG. 2 and FIG. 3). The left end of the half axle 22 at the right end is connected to the differential 13 by using a spline, the half axle 22 at the right end transfers the power output by the differential 13 to the hub assembly 24 at the right end, and then the power actuates the wheels to rotate.

The brake 25 at the right end corresponding to the hub assembly 24 at the right end is mounted to the brake mounting plate 214 at the right end. The brake mounting plate 214 at the right end is fixed to the right end of the axle case component 21. The brake drum 251 of the brake 25 at the right end is further fixed to the hub assembly 24 at the right end to rotate together with the hub assembly 24. For example, the brake mounting plate 214 may be fitted over and fixed through welding to the first half axle case 211 and the second half axle case 212 of the axle case component 21. The brake 25 at the right end is fixed to the brake mounting plate 214 at the right end by using a bolt 404, and the brake drum 251 of the brake 25 at the right end may be fixed to the hub assembly 24 at the right end by using a bolt 405, in which there are plurality of bolts 404 and plurality of bolts 405. In an axial direction, that is, a left-right direction of the vehicle 1000, the brake 25 at the corresponding end is located between the brake mounting plate 214 at the corresponding end and the hub assembly 24 at the corresponding end.

The axial stopper set 27 corresponding to the hub assembly 24 at the right end is a right end set, the stop nut 271 of the right end set and the locking sheet 272 of the right end set are both fitted over the half axle sleeve 23 at the right end, and the stop nut 271 of the right end set is connected to the half axle sleeve 23 at the right end in a threaded manner to compress the hub assembly 24 at the right end between the locking sheet 272 of the right end set and the brake drum 251 of the brake 25 at the right end. Accordingly, the hub assembly 24 may perform locking in the axial direction by fitting between the stop nut 271 and the brake drum 251 of the brake 25, and the locking sheet 272 may prevent the stop nut 271 from loosening. In an embodiment, each hub assembly 24 is rotatably fitted over the corresponding half axle sleeve 23 by using a hub bearing 241, and the axial stopper set 27 may adjust a clearance of the hub bearing 241.

By means of the foregoing description, a person skilled in the art may derive connection relationships and location relationships among the hub assembly 24, the half axle sleeve 23, the brake 25, the brake mounting plate 214, and the axial stopper set 27 at the left end, and details are not described herein.

In some embodiments, the axle case assembly 102 may further include two ABS sensor components 26. The two ABS sensor components 26 may be fixed to the two brake mounting plates in one-to-one correspondence by using threaded connecting pieces 214. That is, the ABS sensor component 26 at the left end is fixed to the brake mounting plate 214 at the left end, and the ABS sensor component 26 at the right end is fixed to the brake mounting plate 214 at the right end. In an embodiment, the threaded connecting piece may be a screw.

In an embodiment, a sensor head of the ABS sensor component 26 and an induction gear ring 242 of the hub assembly 24 rotate to form an induction voltage signal, the induction voltage signal is output to a control system (for example, an ECU of the vehicle 1000), and the control system controls the brake 25 to be locked during braking.

In an embodiment, the brake 25 may be a brake 25a with a parking function, and can implement parking, that is, a braking function. When the foregoing integrated design is used, a parking device does not need to be additionally disposed, so that the structure of the electric drive axle assembly 100 is simpler at the same time of meeting the use function.

For the electric drive axle assembly 100 according to this embodiment of the present disclosure, the transmission housing 121 connects the power motor 11 and the axle case assembly 102, so as to implement the integrated arrangement of the electric power assembly 101 that includes the power motor 11, the transmission 12, and the differential 13 and the axle case assembly 102 that includes the axle case component 21 and the two half axles 22, thereby improving the transmission efficiency, reducing the mass, and saving space.

In some preferred embodiments, the power motor 11 includes the active cooling structure 111. Active cooling is performed in a form of an internal cooling oil pump or an external coolant, to make the power motor 11 more suitable for long-time, high-rotational-speed, and high-power running. The transmission 12 uses the two-gear automatic transmission 12, so that the structure is simple, the mass is small, the speed ratio is large, the torque is large, relatively strong power performance is achieved, and relatively desirable operability is achieved, and use requirements of general vehicle models can be met. Moreover, all gears of the transmission 12 are helical gears, so that transmission is smooth, transmission torque is large, efficiency is high, and noise is low. In an embodiment, the electric drive axle assembly 100 may include the parking device 14, so as to implement central parking, and make the parking simple and reliable.

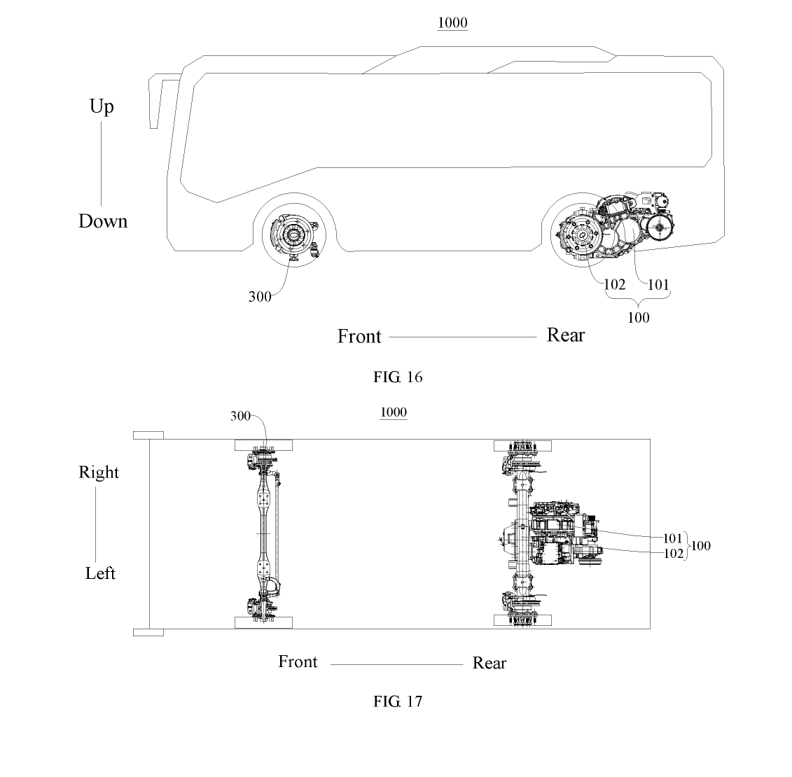

The vehicle 1000 according to the present disclosure is briefly described below with reference to FIG. 16 and FIG. 17. The vehicle 1000 according to this embodiment of the present disclosure includes any electric drive axle assembly 100 in the foregoing embodiment. In some embodiments, the vehicle 1000 may include a front vehicle axle 300 and a rear axle that disposed at an interval in a longitudinal direction of the vehicle 1000, in which the rear axle may employ the electric drive axle assembly 100 according to this embodiment of the present disclosure, so that the transmission chain is short, a small space is occupied, and overall arrangement of the vehicle 1000 is facilitated. Especially, mounting of a battery system of a pure electric vehicle is facilitated, and space is saved to mount the battery system, thereby improving battery endurance.

In the description of the present disclosure, it needs to be understood that, direction or location relationships represented by the terms such as “center”, “longitudinal”, “horizontal”, “length”, “width”, “thickness”, “up”, “down”, “front”, “rear”, “left”, “right”, “vertical”, “horizontal”, “top”, “bottom”, “inside”, “outside”, “clockwise”, “counterclockwise”, “axial direction”, “radial direction”, and “circumferential direction” are based on the direction or location relationships shown in the accompanying drawings, and are only used to facilitate description of the present disclosure and simplify description, rather than to represent or imply that the discussed apparatuses or elements must have specific directions or must be constructed and operated in specific directions. Therefore, the direction or location relationships cannot be understood as a limitation to the present disclosure.

In addition, the terms “first” and “second” are only used for the purpose of description, and should not be can understood to represent or imply relative importance or implicitly represent a quantity of indicated technical features. Accordingly, features that are defined by “first” and “second” may explicitly or implicitly include at least one of the features. In the description of the present disclosure, “multiple” means at least two, for example, two or three, unless otherwise clearly and specifically defined.

In the present disclosure, unless otherwise clearly specified and defined, the terms such as “mount”, “connected”, “connect”, and “fix” should be understood in a broad sense. For example, the terms may represent fixed connection, or may represent detachable connection, or may represent a whole; or may represent mechanical connection, or may represent electric connection or may represent communication; may represent direct connection, or may represent indirect connection by using an intermediate medium, or may represent internal connection between two elements or a mutual effect relationship between two elements, unless otherwise clearly defined. For a person of ordinary skill in the art, specific meanings of the foregoing terms in the present disclosure may be understood according to a specific case.

In the present disclosure, unless otherwise clearly specified and defined, when a first feature is “on” or “under” a second feature, the first feature and the second feature may be in direct contact, or the first feature and the second feature are in indirect contact by using an intermediate medium. Moreover, when the first feature is “on” and “above” the second feature, the first feature may be right above or obliquely above the second feature, or only means that the first feature has a horizontal height greater than that of the second feature. When the first feature is “under” and “below” the second feature, the first feature may be right below the second feature or obliquely below the second feature, or only means that the first feature has a horizontal height less than that of the second feature.

In the description of this specification, the description of reference terms such as “one embodiment”, “some embodiments”, “example”, “specific example”, or “some examples” refer to that specific features, structures, materials or characteristics that are described with reference to the embodiments or examples are included in at least one embodiment or example of the present disclosure. In this specification, schematic description of the foregoing terms does not necessarily involve the same embodiment or example. Moreover, the described specific features, structures, materials or characteristics may be combined in a suitable manner in any one or more embodiments or examples. In addition, without causing any contradictions, a person skilled in the art may combine and group different embodiments or examples and features in different embodiments or examples described in this specification.

Although the embodiments of the present disclosure are shown and described above, it may be understood that the foregoing embodiments are exemplary and cannot be construed as a limitation to the present disclosure. A person of ordinary skill in the art may make changes, modifications, replacements, and variations to the foregoing embodiments within the scope of the present disclosure.

1. An electric drive axle assembly, comprising:
an electric power assembly, comprising a power motor, a transmission, and a differential, wherein the transmission has a transmission housing, the power motor is fixed to the transmission housing, and the differential is supported on the transmission housing; and
an axle case assembly, comprising an axle case component and two half axles, wherein the two half axles and the differential are both located inside the axle case component, and the transmission housing is fixed to the axle case component.

2. The electric drive axle assembly according to claim 1, wherein the power motor comprises an active cooling structure that comprises a coolant circulation passage for cooling the power motor.

3. The electric drive axle assembly according to claim 2, wherein the active cooling structure further comprises a coolant driving member coupled to the coolant circulation passage to drive a coolant to flow inside the coolant circulation passage.

4. The electric drive axle assembly according to claim 1, wherein the axle case component comprises:
a first half axle case and a second half axle case, wherein the first half axle case and the second half axle case are both stamping pieces and are fixed through welding to form an axle case, the axle case defines a space for receiving the two half axles, and the second half axle case and the first half axle case are symmetrically disposed in a longitudinal direction; and
a case cover, detachably mounted to one of the first half axle case and the second half axle case to define a space for receiving the differential among the case cover, the first half axle case, and the second half axle case, wherein the transmission housing is fixed to the other one of the first half axle case and the second half axle case.

5. The electric drive axle assembly according to claim 1, wherein the axle case component comprises: a first half axle case and a second half axle case that are both stamping pieces and are fixed through welding to form an axle case, the axle case defining a space for receiving the two half axles, and the second half axle case and the first half axle case being symmetrically disposed in a vertical direction;
a case cover, detachably mounted to a side surface of the axle case to define a space for receiving the differential among the case cover, the first half axle case, and the second half axle case, wherein the transmission housing is fixed to another side surface of the axle case.

6. The electric drive axle assembly according to claim 1, wherein two half axle sleeves are fixed through welding at two ends of the axle case component respectively, and the axle case assembly further comprises two hub assemblies, each hub assembly being rotatably mounted to a corresponding half axle sleeve, and the two half axle sleeves being fitted over the two half axles in one-to-one correspondence.

7. The electric drive axle assembly according to claim 6, wherein the axle case assembly further comprises two brakes and two brake mounting plates; the two brakes respectively correspond to the two hub assemblies one to one; the two brake mounting plates are fixed through welding at two ends of the axle case component respectively; the two brakes are fixed on the two brake mounting plates in one-to-one correspondence by using threaded connecting pieces, and brake drums of the two brakes are fixed to the two hub assemblies in one-to-one correspondence.

8. The electric drive axle assembly according to claim 7, wherein the axle case assembly further comprises two ABS sensor components, the two ABS sensor components are fixed to the two brake mounting plates in one-to-one correspondence by using threaded connecting pieces.

9. The electric drive axle assembly according to claim 1, wherein the transmission housing comprises a first housing and a second housing; the first housing is detachably connected to the second housing; the power motor is fixed to the first housing; the second housing is fixed to the axle case component; and the differential is supported on the second housing.

10. The electric drive axle assembly according to claim 9, wherein the transmission comprises an input shaft, an intermediate shaft, and an output shaft; the input shaft is connected to a motor output shaft of the power motor and fixed with an input gear; the intermediate shaft is fixed with an intermediate gear engaged with the input gear and fixed with a plurality of gear position driving gears; the output shaft is fixed with an output gear engaged with a differential driven gear of the differential, and a plurality of gear position driven gears engaged with the plurality of gear position driving gears in one-to-one correspondence are freely fitted over the output shaft.

11. The electric drive axle assembly according to claim 10, wherein an end, near the power motor, of the input shaft is supported on the first housing by using a first bearing, an end, away from the power motor, of the input shaft is supported on the first housing by using a second bearing, and the input gear is located between the first bearing and the second bearing.

12. The electric drive axle assembly according to claim 11, wherein the first bearing and the second bearing are both angular contact ball bearings.

13. The electric drive axle assembly according to claim 12, wherein the first bearing comprises a pair of angular contact ball bearings assembled in series.

14. The electric drive axle assembly according to claim 11, wherein an end, away from the power motor, of the first housing is open, and a step portion is disposed at an end, near the power motor, of the first housing;
the transmission further comprises an end cover and a separating sleeve, the separating sleeve being located inside the first housing, and the end cover being fixed to the open end of the first housing, so as to tightly press an outer ring of the second bearing, the separating sleeve, and an outer ring of the first bearing onto the step portion, wherein the outer ring of the second bearing, the separating sleeve, and the outer ring of the first bearing are sequentially disposed in an axial direction of the input shaft from an end away from the power motor to an end near the power motor.

15. The electric drive axle assembly according to claim 10, wherein the intermediate gear is fitted over the intermediate shaft and is fixed with the intermediate shaft by using a gear locking threaded piece; or
the intermediate gear is connected to the intermediate shaft by using a spline structure, the transmission further comprises an elastic retainer ring that is mounted to the intermediate gear, and at least one part of the intermediate shaft is sandwiched between the intermediate gear and the elastic retainer ring in an axial direction.

16. The electric drive axle assembly according to claim 10, wherein the input gear, the intermediate gear, the output gear, the plurality of gear position driving gears, and the plurality of gear position driven gears are all helical gears.

17. The electric drive axle assembly according to claim 10, wherein the input shaft is connected to the motor output shaft of the power motor by using a spline structure or a shaft coupling.

18. The electric drive axle assembly according to claim 10, wherein the electric power assembly further comprises a parking device, the parking device comprises a parking device case that is fixed to the second housing, and the parking device is configured to brake one of the differential driven gear, the output shaft, and the intermediate shaft.

19. The electric drive axle assembly according to claim 9, wherein the electric power assembly further comprises an electrohydraulic gear shift actuating module, and the electrohydraulic gear shift actuating module is configured to control the transmission and is mounted to the second housing.

20. A vehicle, comprising an electric drive axle assembly according to claim 1.
